(19) United States
(12) Patent Application Publication
(10) Pub. No.: US 2014/0187400 A1
(43) Pub. Date: Jul. 3, 2014

(54) ENVELOPING MACHINE

(71) Applicant: Riso Kagaku Corporation, Tokyo (JP)

(72) Inventors: Tadayuki WAKATABI, Ibaraki (JP); Toshio ENDOU, Ibaraki (JP); Yasuhiro KATADA, Ibaraki (JP); Akihiro TSUMURA, Ibaraki (JP)

(73) Assignee: Riso Kagaku Corporation, Tokyo (JP)

(21) Appl. No.: 14/140,935

(22) Filed: Dec. 26, 2013

(30) Foreign Application Priority Data
Dec. 27, 2012 (JP) 2012-284347

(51) Int. Cl. B31B 19/26; B31B 1/88

(52) U.S. Cl. CPC B31B 19/26; B31B 1/88
USPC 493/188

(57) ABSTRACT

An enveloping machine includes a first feed path for feeding an envelope sheet, a second feed path for feeding a content sheet, a feed roller mechanism disposed on the first feed path and provided with nip rollers for feeding the envelope sheet, an insertion and seal unit disposed downstream from a confluent point of the first and second feed paths for inserting the content sheet into the folded envelope sheet and then sealing the folded envelope sheet, a position correction unit disposed upstream from the confluent point for correcting a lateral position of the envelope sheet, and a controller. The controller controls the feed roller mechanism to hold the envelope sheet by the nip rollers, and concurrently controls the position correction unit to shift the envelope sheet laterally to a predetermined lateral position. According to the enveloping machine, time required for position correction of the envelope sheet can be shortened.

### BACKGROUND OF THE INVENTION

1. Technical Field

The present invention relates to an enveloping machine.

2. Background Arts

Generally, a letter(s) is prepared by folding printed content sheets, inserting the folded content sheets into a ready-made envelope, and then sealing the envelope. However, when it is needed to prepare a large number of letters, for example, a company or a retail store wants to prepare and send a large number of advertising mails, it takes great time and effort. Therefore, proposed are various enveloping machines that automatically prepare a large number of letters (folding content sheets, inserting the folded content sheets into an envelope, and sealing the envelope are automatically repeated).

A patent Document 1 (Japanese Patent Application Publication No. 2012-61807) discloses an enveloping machine. The enveloping machine includes a print unit for printing an envelope and a content sheet alternately, and an insertion and seal unit. In the insertion and seal unit, the printed envelope is fed by a first feed path, and the printed content sheet is fed by a second feed path. In addition, the content sheet is inserted into the envelope at a confluent point of the first and second feed paths by an insertion device of the insertion and seal unit. Further, the envelope is sealed by a seal device of the insertion and seal unit, and the sealed envelope is ejected to a stocker.

### SUMMARY OF THE INVENTION

Also proposed is a method for adhering both short side ends of an envelope by using a pressure-sensitive adhesive in order to achieve a complete automation of preparing letters. This method can make inserting and sealing simplified, but capacity for letter contents to be inserted becomes small.

In addition, standard letter sizes are regulated by a postal service provider. If trying to send letters at lower prices, a margin between an inner width of an envelope and a width of a content sheet becomes small inevitably. Therefore, a content sheet may be thrust into areas of the above-explained adhesive on the side ends when the content sheet is misaligned in a direction along the long side, and thereby the side end can't be adhered correctly (or the content sheet is adhered with the envelope by the adhesive).

In order to prevent such a trouble, it is required to align an envelope sheet and a content sheet accurately for inserting and sealing. For example, made is a trial for aligning a centerline of an envelope sheet fed along a first feed path and a centerline of a content sheet fed along a second feed path. However, it takes much time to align them accurately, and thereby productivity was degraded.

An object of the present invention is to provide an enveloping machine that can improve productivity by shortening time required for correcting a position of an envelope sheet.

An aspect of the present invention provides an enveloping machine comprising: a print unit for printing images on an envelope sheet and a content sheet; a first feed path for feeding the envelope sheet printed by the print unit; a second feed path for feeding the content sheet printed by the print unit; a feed roller mechanism that is disposed on the first feed path and includes a pair of nip rollers for nipping the envelope sheet to feed the envelope sheet forward; an insertion and seal unit that is disposed downstream from a confluent point of the first and second feed paths, and folds the envelope so as to insert the content sheet into the folded envelope sheet and seals the folded envelope sheet; a position correction unit that is disposed upstream from the confluent point, and corrects a lateral position of the envelope sheet; and a controller that controls operations of the feed roller mechanism and the position correction unit, wherein the controller controls the feed roller mechanism to hold nipping of the envelope sheet by the pair of nip rollers, and concurrently controls the position correction unit to shift the envelope sheet laterally to a predetermined lateral position.

It may take more time to correct a lateral position of an envelope sheet without the position correction unit. If the position correction unit is not provided, position correction of an envelope sheet may be done by releasing nipping of the envelope sheet by a pair of nip rollers, correcting a lateral position of the envelope sheet by a pair of tampers or the like additionally provided, and then nipping the envelope sheet again by the pair of nip rollers. According to the above aspect, it takes less time to correct a lateral position of an envelope sheet, because the envelope sheet is shifted laterally with nipped by the pair of nip rollers. As a result, productivity can be improved.

It is preferable that the controller controls the feed roller mechanism to feed the envelope sheet forward by the pair of nip rollers, and concurrently controls the position correction unit to shift the envelope sheet laterally to the predetermined lateral position.

According to this configuration, the envelope sheet is fed forward and shifted to the predetermined lateral position concurrently, so that time for required for correcting a lateral position of an envelope sheet can be more shortened. Therefore, productivity can be further improved.

### BRIEF DESCRIPTION OF THE DRAWINGS

FIG. 1 is a schematic configuration diagram of an enveloping machine according to an embodiment;

FIG. 2 is an diagram for explaining a position correction method by an enveloping machine according to a comparative example;

FIG. 3 is an diagram for explaining a first method by the enveloping machine according to the embodiment;

FIG. 4 is an diagram for explaining a second method by the enveloping machine according to the embodiment;

FIG. 5A is a side view showing a feed roller mechanism in the enveloping machine according to the embodiment; and

FIG. 5B is a side view showing the feed roller mechanism that has been slid.

### DESCRIPTION OF THE EMBODIMENTS

Hereinafter, an enveloping machine according to an embodiment will be explained with reference to the drawings.

(Configurations and Operations of Enveloping Machine)

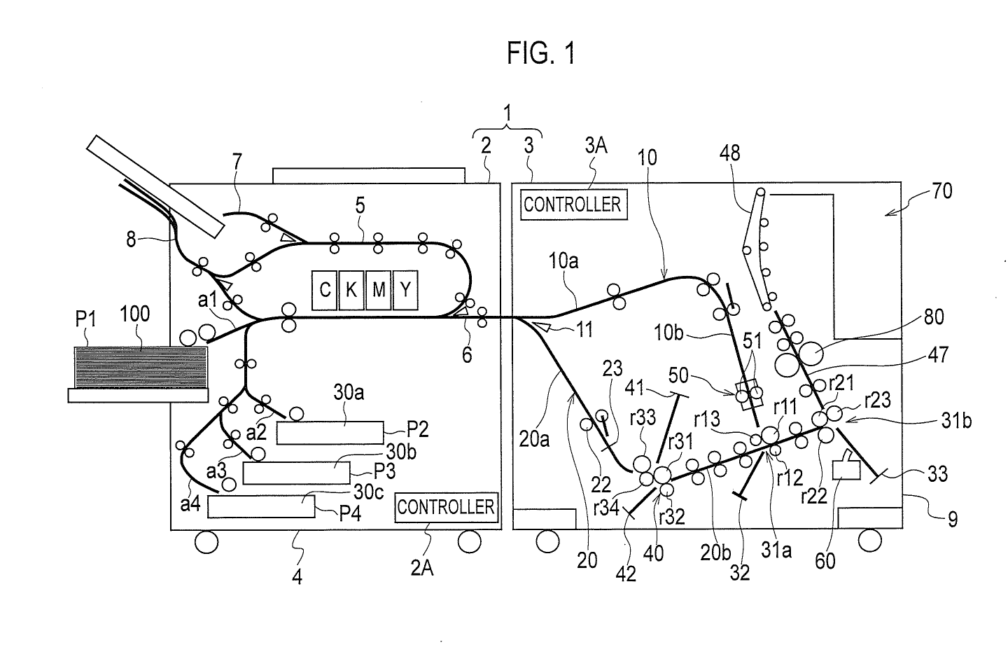

Overall configurations and operations of an enveloping machine 1 according to the present embodiment will be explained with reference to FIG. 1. As shown in FIG. 1, the enveloping machine 1 includes a print unit 2 as a printer for printing images on envelope sheets 100 and content sheets 30a to 30c, and an insertion and seal unit (insertion and seal apparatus) 3 as a finisher for inserting printed content sheets 30a to 30c into envelops made from the envelope sheets 100 and then sealing the envelopes. Inserting and sealing are done as post-processes.

The print unit 2 includes sheet supply trays P (P1 to P4) for stocking plural types of print media (the envelope sheets 100 and the content sheets 30a to 30c) at an inside and a side of a housing 4 accommodating components of the print unit 2. The envelope sheets 100 are stacked on the sheet supply tray P1 disposed at the side of the housing 4. The content sheets 30a to 30c are stocked in the sheet trays (drawers) P2 to P4 disposed in the housing 4. The sheets fed out from the sheet trays P are fed into a loop feed path 5 via feed-in paths a1 to a4, and images are formed on them by an inkjet unit in which print heads are aligned along a lower section of the loop feed path 5 with their inkjet ports oriented downward. The inkjet unit includes four inkjet devices C, K, M and Y for injecting ink droplets of cyan (C), black (K), magenta (M) and Yellow (Y).

A first ejection path 6 for ejecting the sheets almost horizontally is connected with the loop feed path 5 at a downstream from the inkjet unit. In addition, a second ejection path 7 for ejecting the sheets out from the loop feed path 5 is branched from an upper section of the loop feed path 5.

Further, a switchback path 8 is extended from the loop feed path 5 at a position between the second ejection path 7 and the feed-in path from the sheet trays P. The switchback path 8 receives a content sheet 30a to 30c from the upper section of the loop feed path 5, and then feeds out the content sheet 30a to 30c to the lower section of the loop feed path 5. As a result, the content sheet 30a to 30c is turned over for duplex printing. By feeding a content sheet 30a to 30c through the lower section of the loop feed path 5, i.e. through the inkjet unit using the switchback path 8, color images can be printed on both sides of the content sheet 30a to 30c by the inkjet devices C, K, M and Y. Note that the print unit 2 includes a controller 2A, and operations of the above-explained components are controlled by the controller 2A. The controller 2A is configured of a microcomputer or the like.

The insertion and seal unit 3 is disposed next to the print unit 2. The insertion and seal unit 3 receives the envelope sheet 100 and the content sheets 30a to 30c fed from the print unit 2 through the first ejection path 6, and then operates the post-processes (folding the content sheets 30a to 30c, inserting the folded content sheets 30a to 30c as the letter contents into envelopes made from the envelope sheets 100, and sealing the envelopes).

As shown in FIG. 1, the first ejection path 6 is horizontally extended out from the housing 4 of the print unit 2, and into a housing 9 of the insertion and seal unit 3. In the housing 9, the first ejection path 6 is branched to a first feed path 10 extended obliquely upward for feeding the printed envelope sheets 100 and a second feed path 20 extended obliquely downward for feeding the printed content sheets 30a to 30c (letter contents). Note that a feed forward path of the sheets can be switched over to the first feed path 10 or the second feed path 20 by a flap 11.

The first feed path 10 includes a first sloped section 10a sloped obliquely upward and a second sloped section 10b sloped obliquely downward. The first feed path 10 configures a guide path for guiding the envelope sheets 100 to a first folding unit 31a that is part of an insertion and seal unit. A position correction unit 50 for correcting a lateral position of an envelope sheet 100 is disposed at a downstream end of the second sloped section 10b. On the other hand, the second feed path 20 includes a first sloped section 20a sloped obliquely downward and a second sloped section 20b sloped obliquely upward. A folding unit 40 is interposed between the first sloped section 20a and the second sloped section 20b.

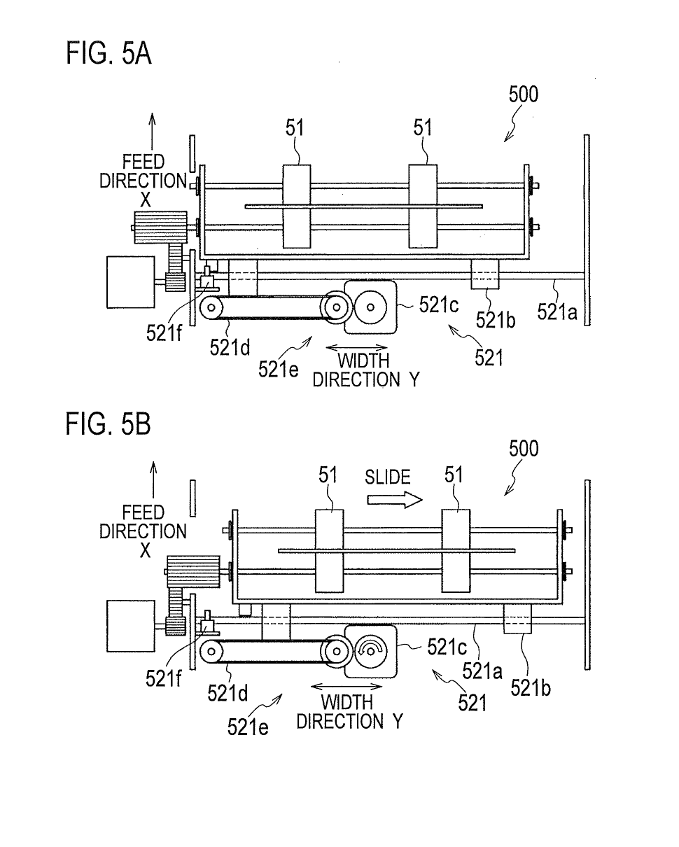

The position correction unit 50 disposed at the downstream end of the first feed path 10 includes a feed roller mechanism 500 (see FIG. 5A and FIG. 5B) that can shift an envelope sheet 100 laterally along its width direction while keeping the envelope sheet 100 nipped by feed rollers 51 of the feed roller mechanism 500. According to the position correction unit 50, it takes less time to correct a lateral position of an envelope sheet 100. If the position correction unit 50 is not provided, position correction of an envelope sheet 100 may be done by releasing nipping of the envelope sheet 100 by the feed rollers 51, correcting a lateral position of the envelope sheet 100 by a pair of tampers or the like additionally provided, and then nipping the envelope sheet 100 again by the feed rollers 51.

Therefore, time required for correcting a lateral position of an envelope sheet 100 can be shortened according to the enveloping machine 1 in the present embodiment. As a result, productivity can be improved by the enveloping machine 1 in the present embodiment. Note that the feed roller mechanism 500 of the position correction unit 50 will be explained later in detail.

In addition, the first folding unit 31a is disposed at an intermediate position of the second sloped section 20b of the second feed path 20. The first folding unit 31a folds an envelope sheet 100 to make an envelope. The first folding unit 31a includes a main folding roller r11 driven by a motor (not shown), a sheet feed roller r13, and a first folding roller r12. The sheet feed roller r13 and the first folding roller r12 are passively rotated by rotations of the main folding roller r11. Outer circumferences of the rollers r11 to r13 is made of rubber. Therefore, when folding an envelope sheet 100, a pressing force applied to the envelope sheet 100 by the rollers r11 to r13 is made relatively small. Each lateral length of the rollers r11 to r13 is made longer than a lateral width of an envelope sheet 100.

Note that an end of the second feed path 20 is introduced to a second folding unit 31b that is part of the insertion and seal unit. In addition, a waiting portion 32 where a once-folded envelope sheet 100 is temporarily waited is provided near the first folding unit 31a.

Sheet feed rollers 22 and an aligning unit 23 are provided at an intermediate of the first sloped section 20a, and the aligning unit 23 is a gate that is opened or closed. The aligning unit 23, when its gate is closed, holds content sheets 30a to 30c sequentially fed along the first sloped section 20a to stack them on the first sloped section 20a. Note that an aligning device such as a tamper for laterally aligning the stacked content sheets 30a to 30c is provided in the aligning unit 23. In addition, the second feed path 20 is laterally set off by a predetermined distance. For example, an offset (=the predetermined distance) of the second feed path 20 is made larger than a lateral deviation of the stacked content sheets 30a to 30c before aligned by the aligning device.

In addition, the folding unit 40 for folding stacked content sheets 30a to 30c is provided at an end of the first sloped section 20a. The folding unit 40 includes a main folding roller r34 driven by a motor (not shown), a first folding roller r33, a second folding roller r31, and a sheet feed roller r32. Outer circumferences of the rollers r31 to r34 is made of rubber. Therefore, when folding content sheets 30a to 30c, a pressing force applied to the content sheets 30a to 30c by the rollers r31 to r34 is made relatively small. Each lateral length of the rollers r31 to r34 is made longer than a lateral width of a content sheet 30a to 30c.

Further, an end guide 41 is provided at a forward position along a feed direction by the first folding roller r33 and the main folding roller r34. A leading edge of a stack of the aligned content sheets 30a to 30c fed forward by the first folding roller r33 and the main folding roller r34 are contacted with the end guide 41, so that a slack is formed on the content sheets 30a to 30c. Then, the slack is introduced between the main folding roller r34 and the second folding roller r31 to fold the content sheets 30a to 30c. Similarly, an end guide 42 is provided at a forward position along a feed direction by the main folding roller r34 and the second folding roller r31. A leading edge of the stack of the content sheets 30a to 30c fed forward by the main folding roller r34 and the second folding roller r31 is contacted with the end guide 42, so that a slack is formed on the sheet. Then, the slack is introduced between the second folding roller r31 and the sheet feed roller r32 to fold the content sheets 30a to 30c. According to the folding unit 40, the content sheets 30a to 30c can be folded twice.

As explained above, the first folding unit 31a for folding envelope sheets 100 is provided at an intermediate of the second sloped section 20b, and the second folding unit 31b is provided at an end of the second sloped section 20b. The second folding unit 31b further folds the envelope sheets 100 that has been already folded once by the first folding unit 31a and into which folded content sheets 30a to 30c (letter contents) has been inserted. The second folding unit 31b inserts the letter contents, and concurrently folds the once-folded envelope sheets 100. The second folding unit 31b also seals the envelope sheet 100. The second folding unit 31b includes a main folding roller r21 driven by a motor (not shown), a sheet feed roller r22, and a folding roller r23. The sheet feed roller r22 and the folding roller r23 are passively rotated by rotations of the main folding roller r21. Outer circumferences of the rollers r21 to r23 is made of rubber. Therefore, when folding the once-folded envelope sheet 100, a pressing force applied to the envelope sheet 100 (and the letter contents therein) by the rollers r21 to r23 is made relatively small. Each lateral length of the rollers r21 to r23 is made longer than a lateral width of the envelope sheet 100.

In addition, a waiting portion 32 where the envelope sheet 100 before sealed is temporarily waited is provided between the sheet feed roller r22 and the folding roller r23. A wetting unit 60 for wetting a water-sensitive adhesive pasted on an envelope sheet 100 is provided near the waiting portion 32. The wetting unit 60 is an adhesion unit that seals an envelope sheet 100 to complete it as an envelope.

A path 47 sloped obliquely upward is provided between the main folding roller r21 and the folding roller r23 of the second folding unit 31b. Pressing rollers 80 as a pressing unit are provided at an intermediate of the path 47. The pressing rollers 80 (pressing unit) are part of the insertion and seal unit. The pressure rollers 80 applies a given pressure force to pressure-sensitive adhesives pasted on both side ends of an envelope sheet 100. For example, each outer circumferential of the pressure rollers 80 is made of metal having relatively high rigidity. The pressure rollers 80 are provided in two pairs, and each of the two pairs has two pressure rollers 80. One of the two pairs presses one side end of an envelope sheet 100 and another of the two pairs presses another side end of the envelope sheet 100, so that the envelope sheet 100 is sealed by the pressure-sensitive adhesives pasted on the both side ends of the envelope sheet 100. A feed unit 48 for feeding a sealed envelope upward is provided above the pressing rollers 80 (pressing unit). Envelopes fed by the feed unit 48 are sequentially stacked on a stocking portion 70 disposed near the feed unit 48.

Note that the insertion and seal unit 3 further includes a controller 3A, and operations of the above-explained components are controlled by the controller 3A. The controller 3A is configured of a microcomputer or the like. Namely, the controller 3A communicates with the controller 2A of the print unit 2, and operations of the enveloping machine 1 are controlled by the controllers 2A and 3A.

Hereinafter, overall operations of the enveloping machine 1 having the above-explained configurations will be simply explained. In the enveloping machine 1, processes are done for each type of letters to be made.

First, desired printings are made on an envelope sheet 100 and content sheets 30a to 30c by the print unit 2 in a given order. Next, the printed envelope sheet 100 and the printed content sheets 30a to 30c are fed to the insertion and seal unit 3. Then, the envelope sheet 100 and the content sheets 30a to 30c are fed through the separated paths (the first feed path 10 and the second feed path 20), respectively. The content sheets 30a to 30c are folded to be made as letter contents. Concurrently, a lateral position of the envelope sheet 100 is corrected by the position correction unit 50, and then folded once at the first folding unit 31a. At the second folding unit 31b, the folded content sheets 30a to 30c (letter contents) are inserted into the once-folded envelope sheet 100, and then the envelope sheet 100 is further folded and a flap of the envelope sheet 100 is sealed by water-sensitive adhesive. Sequentially, the pressing rollers 80 (pressing unit) seals the side ends of the twice-folded envelope sheet 100 (containing the content sheets 30a to 30c therein) to complete a letter (i.e. a letter composed of the envelope made from the envelope sheet 100 and the letter contents contained in the envelope). The letter is ejected upward, and then stocked at the stocking portion 70.

(Position Correction by Comparative Example)

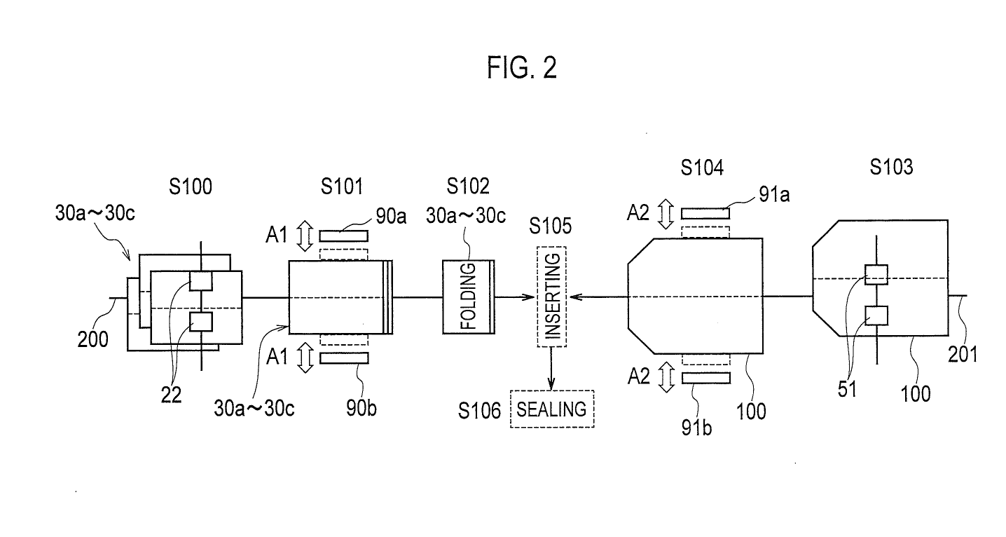

Before explaining a position correction method by the above-explained enveloping machine 1 according to the present embodiment, a position correction method by an enveloping machine according to a comparative example will be explained with reference to FIG. 2. In the comparative example shown by FIG. 2, processes for content sheets 30a to 30c are done in steps S100 to S102, and processes for an envelope sheet 100 are done in steps S103 and S104. Note that the processes in steps S100 to S102 and the processes in steps S103 and S104 are not executed sequentially in a step order, but executed concurrently (simultaneous parallel processings). Overall configurations of the enveloping machine according to the comparative example are almost equivalent to those of the enveloping machine 1 according to the above-explained embodiment shown in FIG. 1. They are different from each other in that the lateral offset of the second feed path 20 is not provided in the comparative example and configurations for position correction in the comparative example is different from those in the above-explained present embodiment.

As shown in FIG. 2, nipping by the sheet feed rollers 22 is released and the gate of the aligning unit 23 is closed to stack the content sheets 30a to 30c (step S100). Since the content sheets 30a to 30c were supplied from the different sheet supply trays P2 to P4 and fed through a relatively long path including the second feed path 20, an undesirable lateral deviation and an undesirable lateral shift occur in the content sheets 30a to 30c stacked at the aligning unit 23 as shown in FIG. 2. Note that a centerline 200 shown in FIG. 2 is a reference line for aligning the content sheets 30a to 30c.

Subsequently, the stacked content sheets 30a to 30c are laterally aligned by lateral back-and-forth movements of a pair of tampers 90a and 90b (see arrows A1 in FIG. 2) so that centerlines of the content sheets 30a to 30c are made coincident with the centerline 200. In addition, the aligned content sheets 30a to 30c are nipped again by the sheet feed rollers 22 (step S101). In step S101, alignment (elimination of the lateral deviation of the content sheets 30a to 30c) and position correction (the centerlines of the content sheets 30a to 30c are made coincident with the centerline 200) by the tampers 90a and 90b takes about 190 ms, and re-nipping by the sheet feed rollers 22 takes about 160 ms. Then, the content sheets 30a to 30c are fed forward to the folding unit 40.

The aligned content sheets 30a to 30c are folded by the folding unit 40 to be made as letter contents (step S102), and the folded content sheets 30a to 30c (letter contents) are waited at the waiting portion 32 (see FIG. 1) until an inserting process in step S105 is started.

Next, processes for an envelope sheet 100 in the comparative example will be explained. An envelope sheet 100 is fed to a predetermined position for position correction by the feed rollers 51 through the first feed path 10 (step S103). Since the envelope sheet 100 was fed through a relatively long path including the first feed path 10, an undesired lateral shift of the envelope sheet 100 occurs at the predetermined position (i.e. at the position correction unit 50) as shown in FIG. 2. Note that a centerline 201 shown in FIG. 2 is a reference line for correcting a lateral position of the envelope sheet 100.

Subsequently, nipping by the feed rollers 51 is released, and then a lateral position of the envelope sheet 100 is corrected by lateral back-and-forth movements of a pair of tampers 91a and 901 (see arrows A2 in FIG. 2) so that the centerline of the envelope sheet 100 is made coincident with the centerline 201. In addition, the envelope sheet 100 is nipped again by the feed rollers 51 (step S104). In step S104, releasing of nipping by the feed rollers 51 takes about 100 ms, position correction (the centerline of the envelope sheet 100 is made coincident with the centerline 201) by the tampers 91a and 91b takes about 190 ms, and re-nipping by the feed rollers 51 takes about 160 ms. Therefore, about 450 ms must be required in total. Then, the envelope sheet 100 is fed forward to the first folding unit 31a.

After the processes in step S102 and S104, the envelope sheet 100 is folded once by the first folding unit 31a. Then, the folded content sheets 30a to 30c (letter contents) are inserted into the once-folded envelope sheet 100 (step S105), and then the once-envelope sheet 100 (into which the folded content sheets 30a to 30c are already inserted) is further folded and sealed by the second folding unit 31b. Subsequently, side ends of the twice-folded envelope sheet 100 (containing the content sheets 30a to 30c therein) are sealed by the pressing rollers 80 (pressing unit) (step S106).

It is desired to shorten time required for the above operations to improve productivity. The above-explained enveloping machine 1 according to the present embodiment can improve productivity.

(Position Correction by Embodiment)

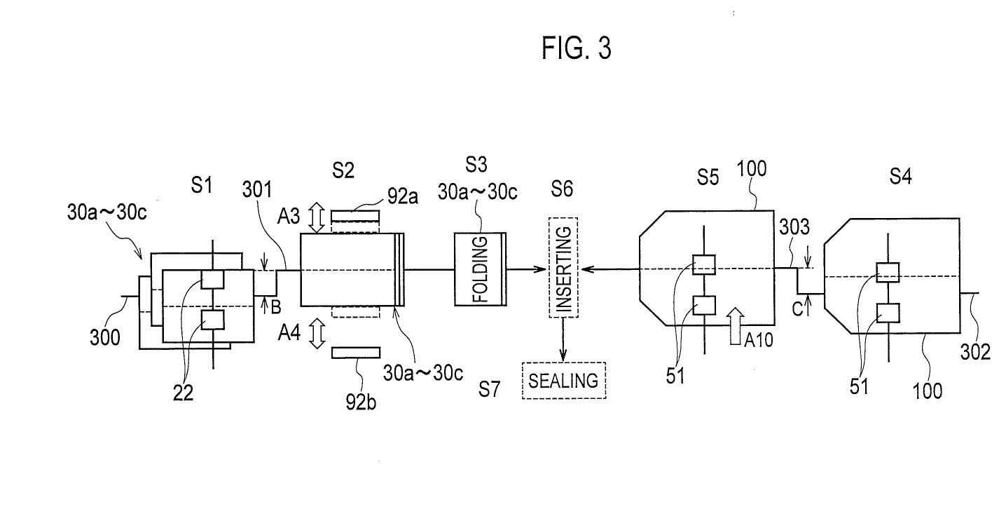

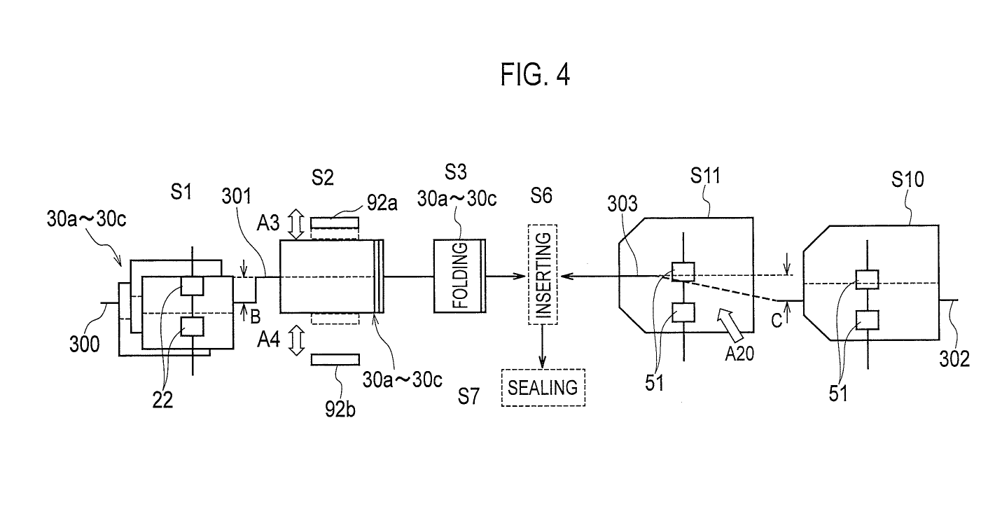

Next, a position correction method by the enveloping machine 1 according to the present embodiment will be explained with reference to FIG. 3 and FIG. 4. Note that position correction by the enveloping machine 1 is controlled by the controller 3A.

As shown in FIG. 3, in a first example of position correction by the enveloping machine 1, processes for content sheets 30a to 30c are done in steps S1 to S3, and processes for an envelope sheet 100 are done in steps S4 and S5. Note that the processes in steps S1 to S3 and the processes in steps S4 and S5 are not executed sequentially in a step order, but executed concurrently (simultaneous parallel processings).

As shown in FIG. 1, nipping by the sheet feed rollers 22 is released and the gate of the aligning unit 23 is closed to stack the content sheets 30a to 30c (step S1). Since the content sheets 30a to 30c were supplied from the different sheet supply trays P2 to P4 and fed through a relatively long path including the second feed path 20, a lateral deviation and an undesirable lateral deviation and an undesirable lateral shift occur in the content sheets 30a to 30c stacked at the aligning unit 23 as shown in FIG. 3. Note that a centerline 300 shown in FIG. 3 is a reference line of the second feed path 20.

Subsequently, the stacked content sheets 30a to 30c are laterally aligned by lateral back-and-forth movements of a pair of tampers 92a and 92b (see arrows A3 and A4 in FIG. 3) so that centerlines of the content sheets 30a to 30c are made coincident with a centerline 301 that is a reference line for aligning the content sheets 30a to 30c. In addition, the aligned content sheets 30a to 30c are nipped again by the sheet feed rollers 22 (step S2). Here in the enveloping machine 1, the second feed path 20 is provided with the above-explained offset (=the predetermined distance) B. For example, the lateral deviation and the lateral shift of content sheets 30a to 30c are preliminarily estimated, and then the offset B is made larger than a total maximum value (e.g. about 5 mm) of the lateral deviation and the lateral shift of stacked content sheets 30a to 30c in consideration of the estimation. In the present embodiment, the offset B is set to 5 to 10 mm. In addition, lateral strokes of the tampers 92a and 92b are set to about 15 mm.

Since the lateral offset B is set as explained above, a direction required for alignment and position correction of the content sheets 30a to 30c can be restricted to a single direction (an upward direction in FIG. 3). Note that, in step S101, alignment (elimination of the lateral deviation of the content sheets 30a to 30c) and position correction (the centerlines of the content sheets 30a to 30c are made coincident with the centerline 301) by the tampers 92a and 92b takes about 190 ms, and re-nipping by the sheet feed rollers 22 takes about 160 ms. Therefore, time for required for step S2 is equivalent to the time required for step S101 in the above-explained comparative example. Then, the content sheets 30a to 30c are fed forward to the folding unit 40.

The aligned content sheets 30a to 30c are folded by the folding unit 40 to be made as letter contents (step S3), and the folded content sheets 30a to 30c (letter contents) are waited at the waiting portion 32 (see FIG. 1) until an inserting process in step S6 is started.

Next, processes for an envelope sheet 100 in the first example will be explained. An envelope sheet 100 is fed to a predetermined position for position correction by the feed rollers 51 through the first feed path 10 (step S4). Since the envelope sheet 100 was fed through a relatively long path including the first feed path 10, an undesirable lateral shift of the envelope sheet 100 occurs at the predetermined position (i.e. at the position correction unit 50) as shown in FIG. 3. Note that a centerline 302 shown in FIG. 3 is a line with which the center of the envelope sheet 100 should be made coincided.

Subsequently, position correction of the envelope sheet 100 is done by the position correction unit 50 (step S5). The position correction unit 50 shifts the envelope sheet 100 laterally while keeping the envelope sheet 100 nipped by the feed rollers 51 to a predetermined lateral position. Specifically, the feed roller mechanism 500 (see FIG. 5A and FIG. 5B) of the position correction unit 50 temporarily stops feeding of the envelope sheet 100 to locate the envelope sheet 100 at a reference position along the feed direction while keeping the envelope sheet 100 nipped by the feed rollers 51, and then shifts the envelope sheet 100 nipped by the feed rollers 51 laterally (along the width direction of the envelope sheet 100) to the predetermined lateral position. After shifting the envelope sheet 100 laterally, the envelope sheet 100 is fed forward to the first folding unit 31a.

Here, in a case where the aligning device (the aligning unit 23 including a pair of tampers 92a and 92b) for aligning the content sheets 30a to 30c (letter contents) is disposed at an upstream from the insertion and seal unit on the second feed path 20 as shown in FIG. 1, the above-explained predetermined lateral position to which the envelope sheet 100 is shifted laterally can be set as a position at which a centerline 303 of the shifted envelope sheet 100 extending along the feed direction is made coincided with the centerline 301 of the aligned content sheets 30a to 30c (letter contents) extending along the feed direction to insert the aligned (folded) content sheets 30a to 30c (letter contents) into the folded envelope sheet 100 accurately.

On the other hand, in a case where no aligning device for aligning the content sheets 30a to 30c (letter contents) is disposed at an upstream from the insertion and seal unit on the second feed path 20, the above-explained predetermined lateral position to which the envelope sheet 100 is shifted laterally may be set as a position at which the centerline of the shifted envelope sheet 100 extending along the feed direction is made coincided with the centerline of the aligned (folded) content sheets 30a to 30c (letter contents) fed by the second feed path 20 to insert the folded content sheets 30a to 30c (letter contents) into the folded envelope sheet 100 accurately.

In addition, it is possible that the lateral shift of an envelope sheet 100 is preliminarily estimated, and then an offset (shift distance) C (see FIG. 3) for an envelope sheet 100 is set to an average value of the estimated lateral shift, for example. In this case, a direction required for correcting a lateral position of the envelope sheet 100 can be restricted to a single direction (an upward direction as shown by an arrow A10 in FIG. 3). Therefore, accuracy degradation in position correction caused by play or backlash in a mechanism or the like can be prevented in comparison with a case of position correction by lateral back-and-forth movements, so that high-accuracy position correction can be achieved.

Further, according to the position correction by the position correction unit 50, eliminated can be time required for releasing nipping of the envelope sheet 100 by the feed rollers 51, nipping the envelope sheet 100 again by the feed rollers 51 and so on, in comparison with the above-explained comparison example. In the above-explained comparison example, more time is required for releasing nipping of an envelope sheet 100 by the feed rollers 51, correcting a lateral position of the envelope sheet 100 by the pair of tampers 91a and 91b, and nipping the envelope sheet 100 again by the feed rollers 51.

Time required for the above position correction by the position correction unit 50 is measured through experiments, and it takes about 160 ms. Therefore, according to the first example of the present embodiment, time required for the position correction of an envelope sheet 100 can be extremely shortened from about 450 ms required in the above-explained comparison example, so that productivity of enveloping (making letters) can be improved.

After the processes in step S3 and S5, the envelope sheet 100 is folded once by the first folding unit 31a. Then, the folded content sheets 30a to 30c (letter contents) are inserted into the once-folded envelope sheet 100 (step S6), and then the once-folded envelope sheet 100 (into which the folded content sheets 30a to 30c are already inserted) is further folded and sealed by the second folding unit 31b. Subsequently, side ends of the twice-folded envelope sheet 100 (containing the content sheets 30a to 30c therein) are sealed by the pressing rollers 80 (pressing unit) (step S7).

Next, a second example of position correction by the enveloping machine 1 will be explained with reference to FIG. 4. In the second example, processes for content sheets 30a to 30c are done in steps S1 to S3, and processes for an envelope sheet 100 are done in steps S10 and S11. Note that the processes in steps S1 to S3 and the processes in steps S10 and S11 are not executed sequentially in a step order, but executed concurrently (simultaneous parallel processings). In addition, the processes in steps S1 to S3 are identical to those in the above-explained first example. Therefore, redundant explanations for the processes in steps S1 to S3 are omitted hereinafter.

Processes in steps S10 and S11 for an envelope sheet 100 in the second example will be explained. An envelope sheet 100 is fed to a predetermined position for position correction by the feed rollers 51 through the first feed path 10 (step S10). Since the envelope sheet 100 was fed through a relatively long path including the first feed path 10, a misalignment of the envelope sheet 100 occurs at the predetermined position (i.e. at the position correction unit 50) as shown in FIG. 4. Note that a centerline 302 shown in FIG. 4 is a line with which the center of the envelope sheet 100 should be made coincided.

Subsequently, position correction of the envelope sheet 100 is done by the position correction unit 50 (step S11). In the second example, the position correction unit 50 shifts the envelope sheet 100 laterally to a predetermined lateral position with the envelope sheet 100 nipped by the feed rollers 51 while feeding the envelope sheet 100 forward. Specifically, the envelope sheet 100 nipped by the feed rollers 51 is continuously shifted to the predetermined lateral position with as indicated by an arrow A20 shown in FIG. 4 without temporarily stopped at the reference position in the above-explained first example. Namely, the envelope sheet 100 is shifted laterally while being fed along the feed direction. Note that the predetermined lateral position for the envelope sheet 100 can be set similarly to the above-explained first example.

Also in this case, a direction required for aligning of the envelope sheet 100 can be restricted to a single direction (an upward direction as shown by the arrow A20 in FIG. 4). Therefore, accuracy degradation in position correction caused by play or backlash in a mechanism or the like can be prevented in comparison with a case of position correction by lateral back-and-forth movements, so that high-accuracy position correction can be achieved.

In addition, since the envelope sheet 100 is continuously shifted while being nipped (fed) by the feed rollers 51 as indicated by the arrow A20 without temporarily stopped at the reference position, time required only for position correction of the envelope sheet 100 can be reduced to “zero” substantially. Namely, in the second example, the position correction of the envelope sheet 100 can be done concurrently with feeding of the envelope sheet 100 forward. Therefore, productivity of enveloping (making letters) can be further improved.

(Feed Roller Mechanism 500)

Next, the feed roller mechanism 500 will be explained with reference to FIG. 5A and FIG. 5B. The feed roller mechanism 500 is configured as a slide mechanism for shifting an envelope sheet 100 laterally along a width direction Y of an envelope sheet 100.

As shown in FIG. 5A and FIG. 5B, the feed roller mechanism 500 includes the feed rollers 51, a guide shaft 521a, a slider frame 521b as a slider member, a drive unit 521e, and an initial position detector 521f. As explained above, the feed rollers 51 are configured as a pair of nip rollers for nipping and feeding envelope sheets 100. The feed rollers 51 are rotatably attached to the slider frame 521b. The guide shaft 521a is extended along an axial direction of the feed rollers 51, and fixed to a frame of a main body of the feed roller mechanism 500. The slider frame 521b is slidable along the guide shaft 521a, and restricts a slide direction of the feed rollers 51 (a shift direction of the envelope sheet 100) to the width direction Y. The drive unit 521e has a motor 521c as a drive source for sliding the slider frame 521b, and an endless belt 521d as a power transmitting member. The endless belt 521d is coupled with the slider frame 521b to transmit power of the motor 521c to the slider frame 521b. The power transmitting member may be a rack and pinion or the like. The initial position detector 521f detects whether or not the slider frame 521b (i.e. the feed rollers 51) is at its initial position (waiting position). Specifically, the initial position detector 521f detects whether or not the slider frame 521b is returned to the initial position after a print job is completed. The initial position detector 521f may be an optical sensor, a mechanical sensor or the like.

The feed roller mechanism 500 as the slide mechanism is configured to slide the feed rollers 51 in the width direction Y while the feed rollers 51 keep nipping of an envelope sheet 100.

When processes of a print job are started, the feed roller mechanism 500 is controlled by the controller 3A to shift the feed rollers 51 waited at its initial position as shown in FIG. 5A to the above-explained predetermined lateral position shown in FIG. 5B. As explained above, at the predetermined lateral position, the centerline 303 of an envelope sheet 100 nipped by the feed rollers 51 is made coincided with the centerline 301 of the folded (aligned) content sheets 30a to 30c (see FIG. 3 or FIG. 4).

According to the feed roller mechanism 500, eliminated can be time required for releasing nipping of the envelope sheet 100 by the feed rollers 51, nipping the envelope sheet 100 again by the feed rollers 51 and so on, in comparison with the above-explained comparison example. In the above-explained comparison example, more time is required for releasing nipping of an envelope sheet 100 by the feed rollers 51, correcting a lateral position of the envelope sheet 100 by the pair of tampers 91a and 91b, and nipping the envelope sheet 100 again by the feed rollers 51.

As explained above, according to the enveloping machine 1 in the above embodiment, time required for position correction of an envelope sheet(s) 100 can be shortened, so that productivity can be improved.

The present invention is not limited to the above-mentioned embodiment, and it is possible to embody the present invention by modifying its components in a range that does not depart from the scope thereof Further, it is possible to form various kinds of inventions by appropriately combining a plurality of components disclosed in the above-mentioned embodiment. For example, it may be possible to omit several components from all of the components shown in the above-mentioned embodiment. Scope of the present invention is determined in the context of the claims.

The present application claims the benefit of a priority under 35 U.S.C. §119 to Japanese Patent Application No. 2012-284347, filed on Dec. 27, 2012, the entire content of which is incorporated herein by reference.

What is claimed is:

1. An enveloping machine comprising:
a print unit for printing images on an envelope sheet and a content sheet;
a first feed path for feeding the envelope sheet printed by the print unit;
a second feed path for feeding the content sheet printed by the print unit;
a feed roller mechanism that is disposed on the first feed path and includes a pair of nip rollers for nipping the envelope sheet to feed the envelope sheet forward;
an insertion and seal unit that is disposed downstream from a confluent point of the first and second feed paths, and folds the envelope so as to insert the content sheet into the folded envelope sheet and seals the folded envelope sheet;
a position correction unit that is disposed upstream from the confluent point, and corrects a lateral position of the envelope sheet; and
a controller that controls operations of the feed roller mechanism and the position correction unit, wherein
the controller controls the feed roller mechanism to hold nipping of the envelope sheet by the pair of nip rollers, and concurrently controls the position correction unit to shift the envelope sheet laterally to a predetermined lateral position.

2. The enveloping machine according to claim 1, wherein
the controller controls the feed roller mechanism to feed the envelope sheet forward by the pair of nip rollers, and concurrently controls the position correction unit to shift the envelope sheet laterally to the predetermined lateral position.

3. The enveloping machine according to claim 1, wherein
the controller controls the feed roller mechanism to stop feeding of the envelope sheet forward by the pair of nip rollers but to hold nipping of the sheet by the pair of nip rollers, and concurrently controls the position correction unit to shift the envelope sheet laterally to the predetermined lateral position.

4. The enveloping machine according to claim 1, wherein
the predetermined lateral position is a position that makes a centerline of the envelope sheet coincident with a centerline of the content sheet at the confluent point.
